(19) United States
(12) Patent Application Publication
(10) Pub. No.: US 2012/0047081 A1
(43) Pub. Date: Feb. 23, 2012

(54) Methods and Systems for Real Estate Resource Consolidation

(75) Inventors: Pranay Bajpai, Wesley Chapel, FL (US); Kim Richard Selz, Lakeland, FL (US); Tim Hunniecutt, Brandon, FL (US); Vidhyaprakash Ramachandran, Richardson, TX (US)

(73) Assignee: VERIZON PATENT AND LICENSING, INC., Basking Ridge, NJ (US)

(21) Appl. No.: 12/857,854

(22) Filed: Aug. 17, 2010

(51) Int. Cl. G06Q 10/00

(52) U.S. Cl. 705/313

(57) ABSTRACT

An exemplary method includes a real estate resource consolidation subsystem analyzing source data associated with a plurality of real estate resources and maintained by a plurality of distinct source data management subsystems, automatically generating one or more recommendations for consolidating the real estate resources based on the analyzing of the source data, providing the one or more recommendations for display in a portal, and performing at least one real estate consolidation operation associated with the real estate resources in accordance with at least one recommendation included in the one or more recommendations. Corresponding methods and systems are also described.

### BACKGROUND INFORMATION

Providers of telecommunication, networking, and other data services typically own and/or lease various types of real estate facilities to house equipment used to provide such data services. Some of the larger providers own and/or lease tens of thousands of such real estate facilities. Managing, maintaining, and operating so many real estate facilities is costly, environmentally unfriendly, and logistically very difficult. Thus, providers are always looking for ways to consolidate real estate facilities and/or make existing real estate facilities more efficient in terms of operating expense and energy consumption.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary real estate resource management system according to principles described herein.

FIG. 2 illustrates exemplary components of a real estate resource consolidation subsystem according to principles described herein.

FIG. 3 illustrates an exemplary method of real estate resource consolidation according to principles described herein.

FIG. 4 shows an exemplary graphical user interface (“GUI”) that may be displayed within a portal according to principles described herein.

FIG. 5 illustrates an exemplary method of consolidating first and second real estate facilities according to principles described herein.

FIG. 6 shows another exemplary GUI that may be displayed within a portal according to principles described herein.

FIG. 7 illustrates an exemplary method of consolidating equipment housed by a real estate facility according to principles described herein.

FIG. 8 illustrates another exemplary GUI that may be displayed within a portal according to principles described herein.

FIG. 9 illustrates an exemplary computing device according to principles described herein.

### DETAILED DESCRIPTION OF PREFERRED EMBODIMENTS

Exemplary methods and systems for consolidating real estate resources are described herein. In some examples, a real estate resource consolidation subsystem may analyze source data associated with a plurality of real estate resources and maintained by a plurality of distinct source data management subsystems, automatically generate one or more recommendations for consolidating the real estate resources based on the analysis of the source data, provide the one or more recommendations for display in a portal, and perform at least one real estate consolidation operation associated with the real estate resources in accordance with at least one recommendation included in the one or more recommendations.

As used herein, a “real estate resource” may include a real estate facility, physical space associated with a real estate facility, a piece of equipment housed by a real estate facility, power consumed by a real estate facility and/or components thereof, and/or any other resource associated with a real estate facility as may serve a particular implementation. A “real estate facility” may include any real estate premises owned, leased, and/or otherwise used by any type of enterprise. For example, exemplary real estate facilities include, but are not limited to central offices, data centers, server farms, wireless communication facilities, and/or colocation centers that may be associated with network providers, telecommunication providers, wireless communication providers and/or other types of business entities.

As used herein, a “real estate consolidation operation” refers to any operation associated with consolidating multiple real estate resources that may be performed by a real estate resource consolidation subsystem. For example, a real estate consolidation operation may include any operation associated with closing a real estate facility, selling a real estate facility, terminating a lease of a real estate facility, moving equipment from one real estate facility to another, transferring operations from one real estate facility to another, reducing power consumed by a particular real estate facility and/or piece of equipment, retiring a piece of equipment, moving circuits associated with a piece of equipment to another piece of equipment, updating one or more inventory databases in response to a consolidation of real estate resources, and/or any other consolidation operation as may serve a particular implementation.

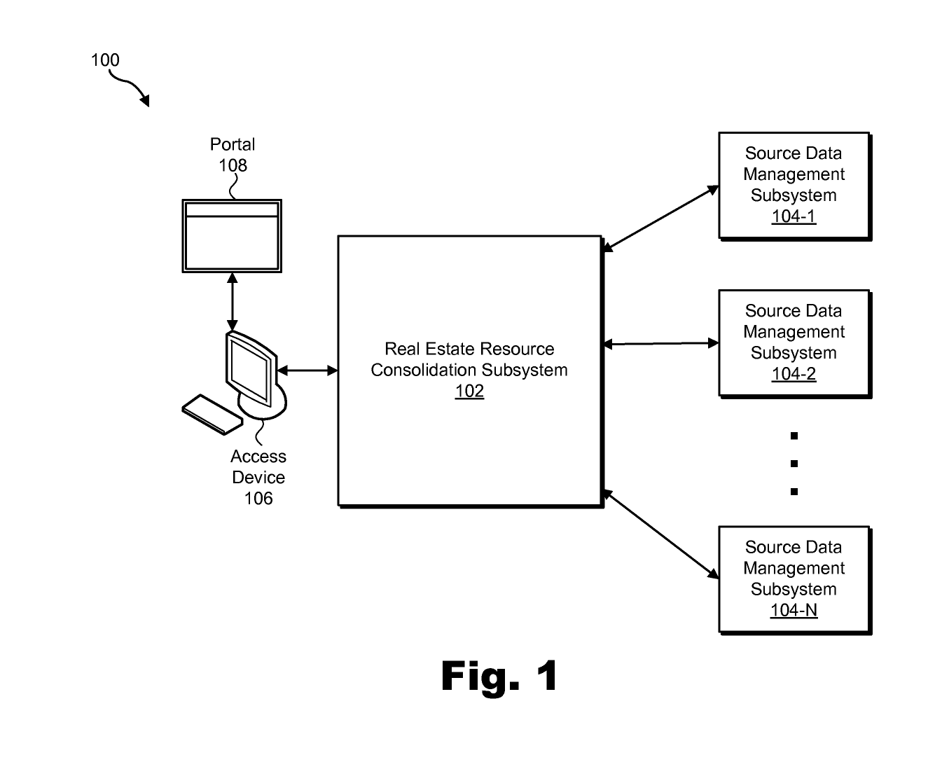

FIG. 1 illustrates an exemplary real estate resource management system 100 (or simply “system 100”). As shown in FIG. 1, system 100 may include a real estate resource consolidation subsystem 102 (or simply “consolidation subsystem 102”) communicatively coupled to a plurality of source data management subsystems 104 (e.g., source data management subsystem 104-1 through 104-N). In some examples, an access device 106 may be communicatively coupled to consolidation subsystem 102 and configured to access and display a portal 108 generated by consolidation subsystem 102.

Components of system 100 may communicate with one another using any suitable communication technologies, devices, media, and protocols supportive of data communications, including, but not limited to, the Internet, intranets, local area networks, other communications networks, data transmission media, communications devices, Transmission Control Protocol (“TCP”), Internet Protocol (“IP”), File Transfer Protocol (“FTP”), Telnet, Hypertext Transfer Protocol (“HTTP”), socket connections, Ethernet, data bus technologies, and other suitable communications technologies. In some examples, components of system 100 may communicate directly with one another without the use of a network.

While an exemplary system 100 is shown in FIG. 1, the exemplary components illustrated in FIG. 1 are not limiting. Other components and/or configurations of components may be used in other implementations. Exemplary components of system 100 will now be described in additional detail.

Consolidation subsystem 102 may be configured to manage and facilitate consolidation of real estate resources utilized by an enterprise associated with consolidation subsystem 102. To this end, as will be described in more detail below, consolidation subsystem 102 may be configured to analyze source data associated with a plurality of real estate resources and maintained by source data management subsystems 104, automatically generate one or more recommendations for consolidating the real estate resources based on the analysis of the source data, provide the one or more recommendations for display in portal 108, and perform at least one real estate consolidation operation associated with the real estate resources based on at least one recommendation included in the one or more recommendations.

Source data management subsystems 104 may each be configured to manage (e.g., generate, store, maintain, update, and/or otherwise process) source data associated with a plurality of real estate resources. In some examples, each source data management subsystem 104 may be configured to maintain a distinct type of source data. For example, distinct source data management subsystems 104 may maintain space data, equipment data, drawings data, circuit data, and power consumption data, respectively. Each of these types of source data will now be briefly described.

“Space data” refers to data descriptive of a physical space (e.g., a site) associated with one or more real estate resources. For example, space data may be descriptive of a geographic location of one or more real estate resources, one or more costs associated with maintaining, leasing, and/or or otherwise managing one or more sites at which the one or more real estate resources are located, and/or any other characteristic associated with a physical space associated with the one or more real estate resources.

“Equipment data” refers to data descriptive of one or more pieces of equipment associated with one or more real estate resources. For example, equipment data may be descriptive of an inventory of equipment that resides within each of a plurality of different real estate facilities. Equipment data may additionally or alternatively be descriptive of one or more costs associated with the one or more pieces of equipment and/or usage data associated with each of the one or more pieces of equipment.

“Drawings data” refers to data representative of one or more maps, diagrams, and/or other types of drawings associated with one or more real estate resources. For example, drawings data may include maps showing geographic locations of the one or more real estate resources, schematic drawings of floor layouts within one or more real estate facilities, diagrams of how equipment is situated within one or more real estate facilities, diagrams of how equipment is interconnected, and/or any other type of drawings data as may serve a particular implantation.

“Circuit data” refers to data descriptive of one or more circuits associated with one or more real estate resources. As used herein, a “circuit” may refer to any network-based communication path and associated components that may be provided by, used by, and/or otherwise associated with a network provider and/or customer of the network provider. For example, a network circuit may include a telecommunication circuit, a dedicated circuit, a switched circuit, an analog circuit, a digital circuit, a network path for a local area network, a digital signal (“DS”) circuit (e.g., a T1, T2, or T3 line), and/or any other network-based communication path and associated components as may serve a particular implementation. In some examples, a circuit may be associated with (e.g., used by) a service or product offered by the network provider and/or any other entity. Exemplary services and/or products that use a network circuit include, but are not limited to, private internet protocol (“PIP”) services and products, switched circuit services and products, Internet-based services and products, telecommunication-based services and products, and synchronous optical networking (“SONET”)-based services and products.

“Power consumption data” refers to data representative of how much power is consumed by the one or more real estate resources. The power consumption data may include one or more power bills, technical specifications, and/or other descriptions of the amount of power consumed by the one or more real estate resources. For example, power consumption data may be descriptive of how much power one or more pieces of equipment residing at a particular real estate facility consume.

Source data management subsystems 104 may be heterogeneous and/or may maintain heterogeneous data. For example, one or more of the source data management subsystems 104 may store data according to data schemas that are different from the data schemas used by other source data management subsystems 104. For instance, source data management subsystem 104-1 may employ a first data schema, source data management subsystem 104-2 may employ a second data schema, and source data management subsystem 104-N may employ another data schema. As used herein, a “data schema” or “data schema type” may refer to a definition of one or more properties, technologies, templates, frameworks, formats, data models, and/or business rules that may be used to represent data. For example, a data schema may provide a framework for naming, storing, and accessing different elements of information.

In some examples, consolidation subsystem 102 and/or data source data management subsystems 104 may each include or be in communication with an access device configured to facilitate user access to and/or control of one or more operations performed by consolidation subsystem 102 and/or data source data management subsystems 104. For example, as shown in FIG. 1, consolidation subsystem 102 may be communicatively coupled to access device 106. Access device 106 may include any suitable computing device such as, but not limited to, a personal computer, a communications device, a mobile device (e.g., a mobile phone device), a handheld device, and/or any other computing device as may serve a particular implementation. Access device 106 may also include or interact with various peripherals such as a terminal, keyboard, mouse, screen, printer, stylus, input device, output device, or any other apparatus that can help a user interact with access device 106.

Access device 106 may be configured to access and display a portal 108 generated by consolidation subsystem 102 and configured to facilitate user interaction with one or more features of and/or operations performed by consolidation subsystem 102. Portal 108 may include any suitable graphical user interface as may serve a particular implementation. In some instances, portal 108 is web-based in order to facilitate remote access to the features of consolidation subsystem 102.

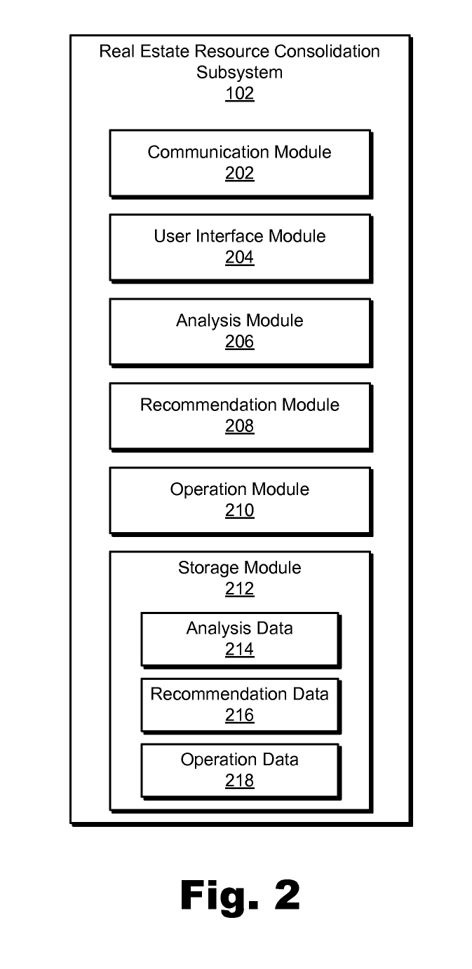

FIG. 2 illustrates exemplary components of consolidation subsystem 102. As shown in FIG. 2, consolidation subsystem 102 may include a communication module 202, a user interface module 204, an analysis module 206, a recommendation module 208, an operation module 210, and a storage module 212, which may be in communication with one another using any suitable communication technologies.

Communication module 202 may be configured to facilitate communication between consolidation subsystem 102 and source data management subsystems 104. For example, communication module 202 may facilitate retrieval of and/or access to source data maintained by source data management subsystems 104. Communication module 202 may be further configured to facilitate communication between consolidation subsystem 102 and access device 106.

User interface module 204 may be configured to provide one or more user interfaces configured to facilitate user interaction with consolidation subsystem 102 for display by access device 106. For example, user interface module 204 may provide portal 108 for display through which one or more functions, options, features, and/or tools may be provided to a user and through which user input may be received.

Analysis module 206 may be configured to analyze source data associated with a plurality of real estate resources and maintained by a plurality of distinct source data management subsystems (e.g., source data management subsystems 104). In some examples, analysis module 206 may perform the analysis in response to a user generated request input by way of portal 108.

For example, analysis module 206 may receive a request by way of portal 108 to analyze an efficiency of operating multiple real estate facilities. In response to the request, analysis module 206 may analyze space data associated with the real estate facilities, equipment data associated with the real estate facilities, circuit data associated with the real estate facilities, and power consumption data associated with the real estate facilities. As will be described in more detail below, one or more recommendations for consolidating the real estate facilities may be generated based on the analysis performed by analysis module 206.

As another example, analysis module 206 may receive a request by way of portal 108 to reduce power consumption by a real estate facility that houses a plurality of pieces of equipment. In response to the request, analysis module 206 may analyze source data associated with one or more of the pieces of equipment and determine that a first piece of equipment included in the plurality of pieces of equipment and associated with one or more circuits is underutilized. The determination that the first piece of equipment is underutilized may be made by analyzing equipment data, power consumption data, and/or any other type of source data as may serve a particular implementation.

Analysis module 206 may then identify a second piece of equipment included in the plurality of pieces of equipment that has a capacity to handle the one or more circuits and assess a capital cost of consolidating the first and second pieces of equipment. As will be described in more detail below, one or more recommendations for consolidating the first and second pieces of equipment may be generated based on the analysis performed by analysis module 206.

In some examples, analysis module 206 may be configured to convert heterogeneous source data maintained by distinct source data management subsystems 104 into data that may be jointly analyzed. For example, drawings data and equipment data may be converted such that they may be analyzed, displayed, and/or otherwise processed jointly. To illustrate, drawings data and equipment data may be combined to yield interactive maps configured to display information associated with one or more pieces of equipment.

Recommendation module 208 may be configured to automatically generate one or more recommendations for consolidating real estate resources based on the analysis performed by analysis module 206. In some examples, user interface module 204 may provide the one or more recommendations for display in portal 108.

For example, recommendation module 208 may generate a recommendation to consolidate multiple real estate facilities into a single real estate facility based on an analysis of source data associated with the multiple real estate facilities. Recommendation module 208 may also generate one or more recommendations as to how to implement the consolidation of the multiple real estate facilities into the single real estate facility. These recommendations may be displayed within portal 108 so that one or more users may view the recommendations, access additional information associated with the recommendations, and/or direct consolidation subsystem 102 to implement one or more of the recommendations.

As another example, recommendation module 208 may generate a recommendation to consolidate underutilized pieces of equipment based on an analysis of source data associated with the pieces of equipment. Recommendation module 208 may also generate one or more recommendations as to how to implement the consolidation of the pieces of equipment. As described above, these recommendations may be displayed within portal 108 so that one or more users may view the recommendations, access additional information associated with the recommendations, and/or direct consolidation subsystem 102 to implement one or more of the recommendations.

Operation module 210 may be configured to perform one or more real estate consolidation operations associated with one or more real estate resources. As described above, a real estate consolidation operation may include any operation associated with consolidating multiple real estate resources.

In some examples, the one or more real estate consolidation operations may be performed by operation module 210 in accordance with one or more recommendations provided by recommendation module 208. For example, as described above, recommendation module 208 may provide a recommendation to consolidate multiple real estate facilities. Operation module 210 may perform one or more operations associated with consolidating the multiple real estate facilities in accordance with the recommendation. Such operations may include, but are not limited to, any operation associated with closing one or more of the real estate facilities, selling one or more of the real estate facilities, terminating a lease of one or more of the real estate facilities, moving equipment from one of the real estate facilities to another one of the real estate facilities, and/or transferring operations from one of the real estate facilities to another one of the real estate facilities.

In some examples, as will be described in more detail below, operation module 210 may perform one or more real estate consolidation operations in response to input provided by a user by way of portal 108. Additionally or alternatively, operation module 210 may automatically perform one or more real estate consolidation operations in response to the source data meeting at least one predetermined threshold. For example, the source data associated with first and second real estate facilities may indicate that consolidation of the first and second real estate facilities would save a certain amount of money. If the amount saved is over a predetermined threshold, operation module 210 may automatically commence one or more real estate consolidation operations to consolidate the first and second real estate facilities.

Storage module 212 may be configured to maintain analysis data 214 associated with and/or used by analysis module 206, recommendation data 216 representative of one or more recommendations generated by recommendation module 208, and/or operation data 218 used by operation module 210 to perform one or more real estate consolidation operations. It will be recognized that storage module 212 may maintain additional or alternative data as may serve a particular implementation.

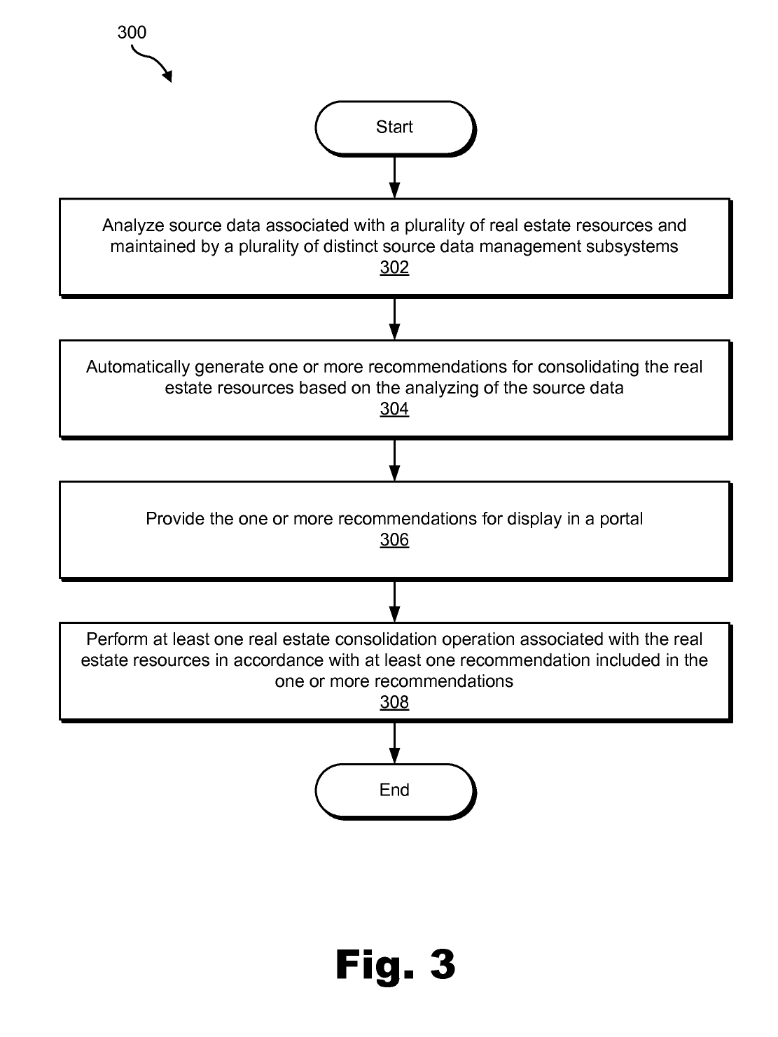

FIG. 3 illustrates an exemplary method 300 of real estate resource consolidation. While FIG. 3 illustrates exemplary steps according to one embodiment, other embodiments may omit, add to, reorder, and/or modify any of the steps shown in FIG. 3. The steps shown in FIG. 3 may be performed by any component of consolidation subsystem 102.

In step 302, source data associated with a plurality of real estate resources and maintained by a plurality of distinct source data management subsystems is analyzed. The source data may be maintained by source data management subsystems 104 and may be analyzed in any of the ways described herein.

In step 304, one or more recommendations for consolidating the real estate resources are automatically generated based on the analyzing of the source data performed in step 302. The automatic generation of the one or more recommendations may be performed in any of the ways described herein.

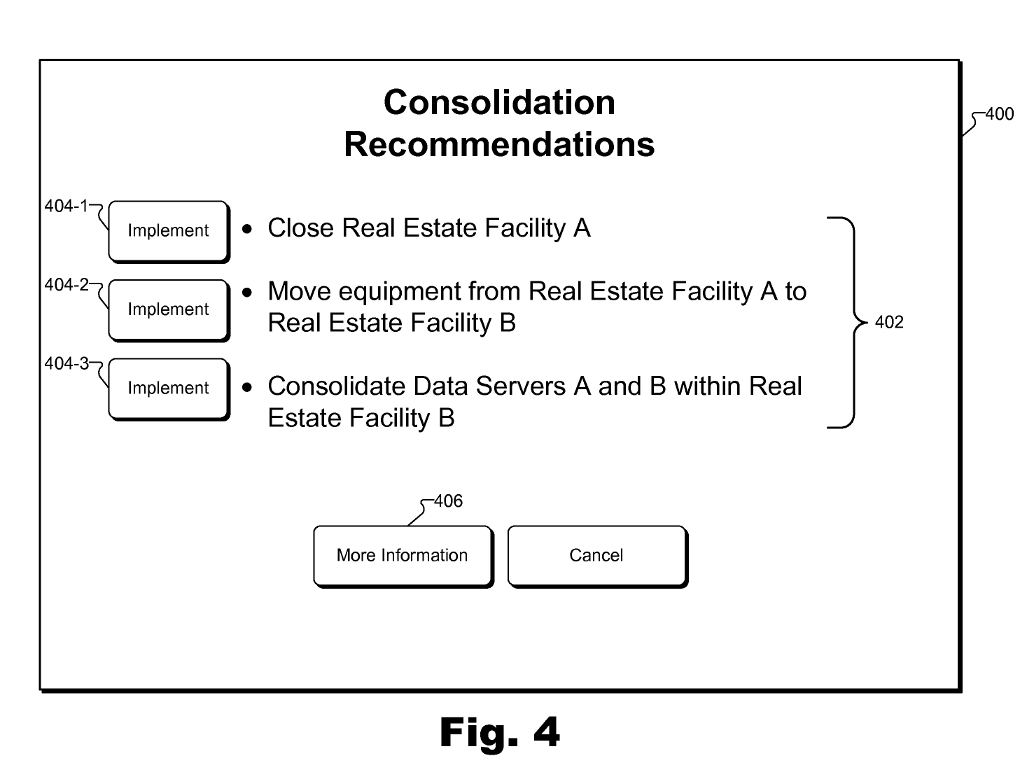

In step 306, the one or more recommendations generated in step 304 are provided for display in a portal. The one or more recommendations may be provided for display in any of the ways described herein. To illustrate, FIG. 4 shows an exemplary graphical user interface (“GUI”) 400 that may be displayed within portal 108. As shown in FIG. 4, a plurality of recommendations 402 associated with consolidating various real estate resources (e.g., real estate facilities A and B and data servers A and B) may be displayed within GUI 400. Recommendations 402 may be generated in response to an analysis of source data associated with real estate facilities A and B and data servers A and B. As shown in FIG. 4, various options 404 (e.g. option 404-1 through option 404-3) may be displayed within user interface 400 and selected by a user to implement one or more of recommendations 402. In some examples, as shown in FIG. 4, an option 406 may be selected by a user to access additional information associated with one or more of recommendations 402. It will be recognized that additional or alternative information may be displayed within GUI 400 as may serve a particular implementation.

Returning to FIG. 3, in step 308, at least one real estate consolidation operation associated with the real estate resources is performed in accordance with at least one recommendation included in the one or more recommendations generated in step 304. The at least one real estate consolidation operation may be performed in any of the ways described herein.

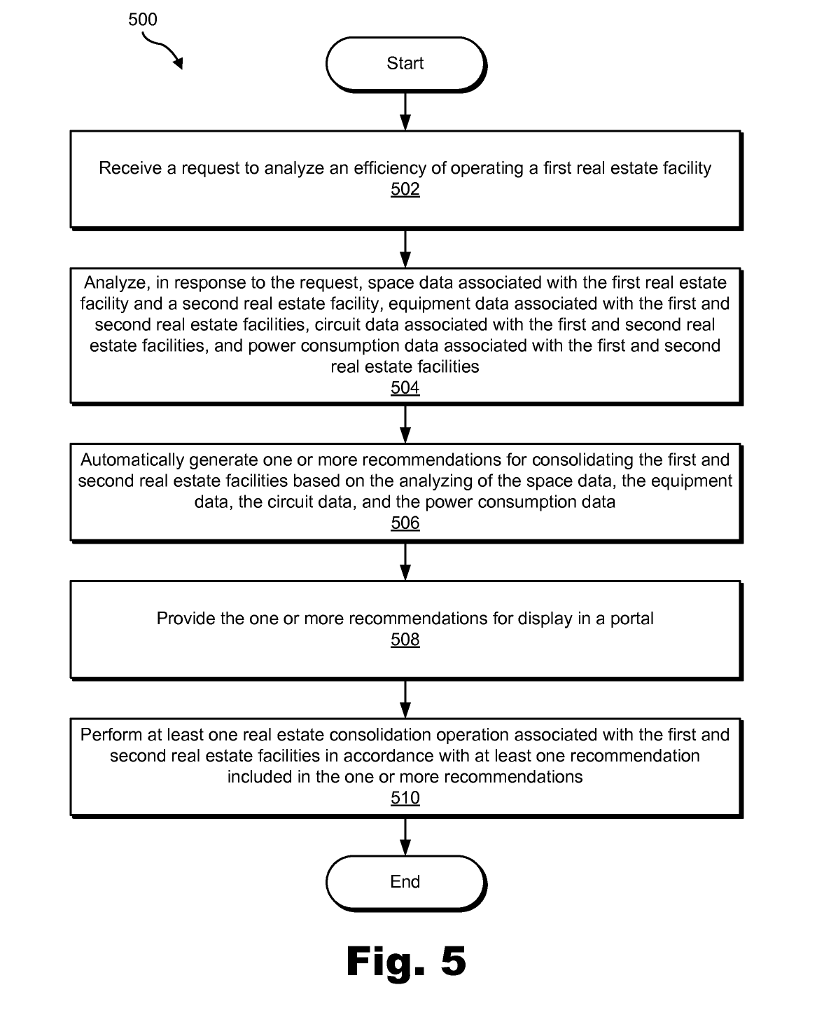

An example of consolidating multiple real estate facilities will now be given in connection with the flowchart of FIG. 5. In particular, FIG. 5 illustrates an exemplary method 500 of consolidating first and second real estate facilities. The first and second real estate facilities may include any of the real estate facilities described herein. While FIG. 5 illustrates exemplary steps according to one embodiment, other embodiments may omit, add to, reorder, and/or modify any of the steps shown in FIG. 5. The steps shown in FIG. 5 may be performed by any component of consolidation subsystem 102.

In step 502, a request to analyze an efficiency of operating a first real estate facility is received. The request may be received in any suitable manner as may serve a particular application. In some examples, the request may be input by a user by way of portal 108.

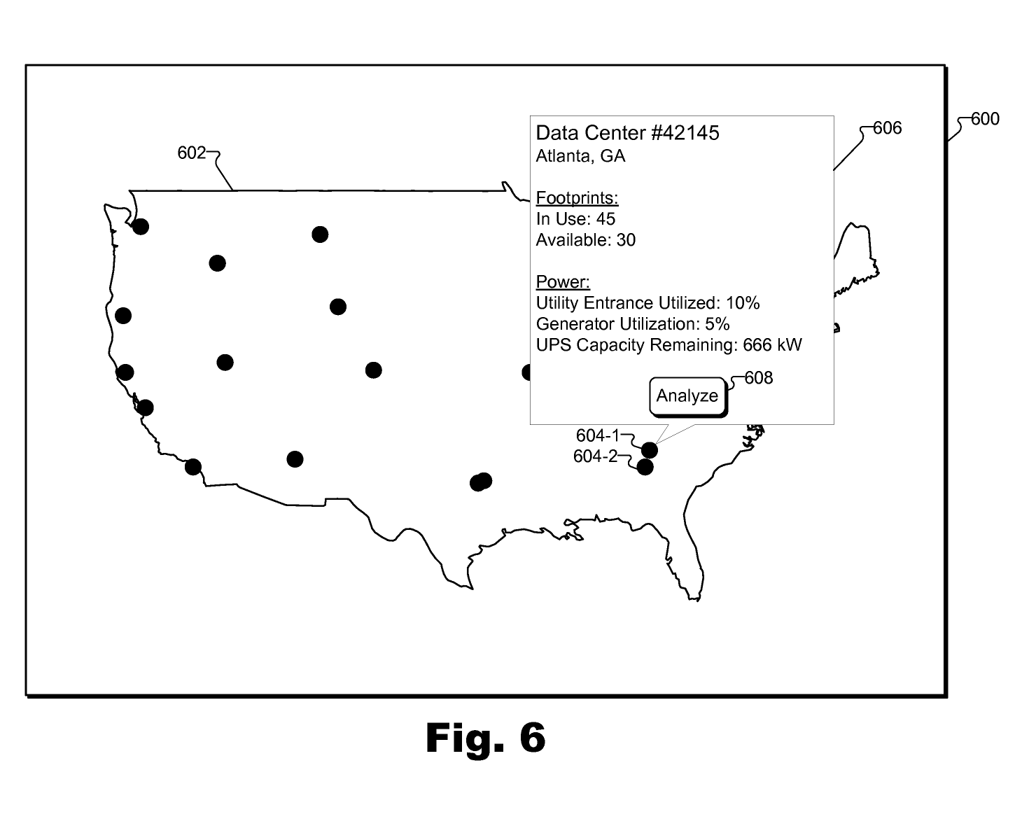

To illustrate, FIG. 6 shows an exemplary GUI 600 that may be displayed within portal 108 and that may be used to facilitate input of the request to analyze the efficiency of operating the first real estate facility. As shown in FIG. 6, GUI 600 may include an interactive map 602 with a plurality of graphical markers 604 (e.g., graphical markers 604-1 and 604-2) displayed thereon. Each graphical marker 604 may represent a real estate facility and may be positioned at a location within map 602 that corresponds to a geographic location of the real estate facility. A user may select a particular graphical marker (e.g. graphical marker 604-1) to display information associated with the corresponding real estate facility. The information may be displayed within a pop-up window, such as pop-up window 606, and/or in any other manner as may serve a particular implementation. As shown FIG. 6, the information may include usage information and/or any other information associated with the real estate facility.

In some examples, a user may utilize GUI 600 to submit a request to consolidation subsystem 102 to analyze the efficiency of one or more real estate facilities represented by graphical markers 604. For example, a user may select an option 608 to submit a request to analyze the efficiency of the real estate facility represented by graphical marker 604-1.

Returning to FIG. 5, in step 504, in response to the request received in step 502, consolidation subsystem 102 analyzes source data associated with the first real estate facility and source data associated with a second real estate facility. The source data may include space data, equipment data, circuit data, and/or power consumption data associated with the first and second real estate facilities.

The second real estate facility may be selected by consolidation subsystem 102 based on a proximity of the second real estate facility to the first real estate facility, a common operation of the second real estate facility with the first real estate facility, and/or in accordance with any other factor as may serve a particular implementation. For example, returning to FIG. 6, the first real estate facility may be represented by graphical marker 604-1 and the second real estate facility may be represented by graphical marker 604-2. As shown in FIG. 6, the first and second real estate facilities are located relatively close to one another and may therefore be candidates for possible consolidation.

In step 506, one or more recommendations for consolidating the first and second real estate facilities are automatically generated based on the analysis performed in step 504. The automatic generation of the one or more recommendations may be performed in any of the ways described herein. For example, the analysis of source data associated with the first and second real estate facilities may determine that one or both of the real estate facilities are being underutilized, cost too much to operate, and/or are redundant in the operations that they perform. Hence, a recommendation to consolidate the first and second real estate facilities into a single real estate facility may be generated by consolidation subsystem 102 based on this analysis. It will be recognized that one or more additional or alternative recommendations may be generated by consolidation subsystem 102 as may serve a particular implementation.

In step 508, the one or more recommendations generated in step 506 are provided for display in a portal (e.g. portal 108). In this manner, personnel responsible for making a determination as to whether to consolidate the first and second real estate facilities may view and act upon the one or more recommendations provided in step 506.

In step 510, at least one real estate consolidation operation associated with the first and second real estate facilities is performed in accordance with at least one recommendation included in the one or more recommendations provided in step 506. The at least one real estate consolidation operation may be performed in any of the ways described herein. For example, the at least one real estate consolidation operation may be performed in response to user input provided by way of portal 108 and/or automatically as may serve a particular implementation.

To illustrate, after reviewing the one or more recommendations displayed in portal 108, a user may input a command by way of portal 108 for consolidation subsystem 102 to implement at least one of the one or more recommendations. For example, a user may direct consolidation subsystem 102 to initiate a closing of one of the real estate facilities. The closing of the real estate facility may be initiated by generating one or more required documents needed to perform the closing and/or any other operation as may serve a particular implementation.

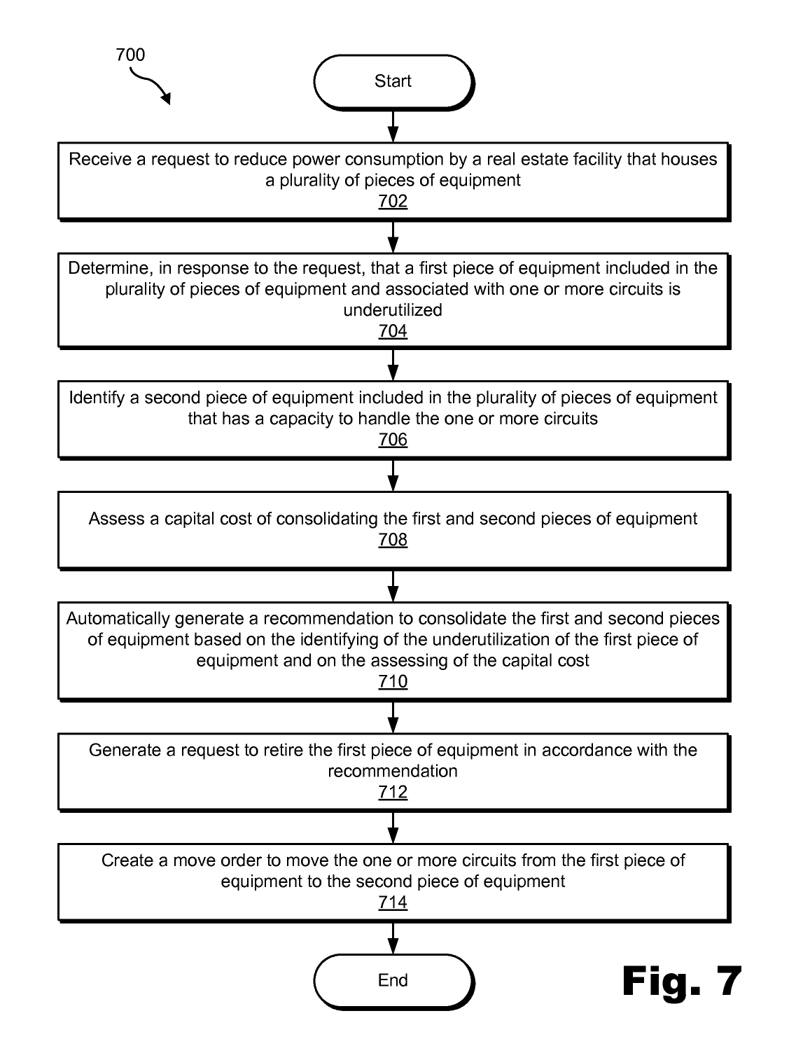

Another example of real estate consolidation will now be given in connection with the flowchart of FIG. 7. FIG. 7 illustrates an exemplary method 700 of consolidating equipment housed by a real estate facility. As will be described in more detail below, method 700 may be used to reduce power consumption by the real estate facility and/or one or more pieces of equipment within the real estate facility. While FIG. 7 illustrates exemplary steps according to one embodiment, other embodiments may omit, add to, reorder, and/or modify any of the steps shown in FIG. 7. The steps shown in FIG. 7 may be performed by any component of consolidation subsystem 102.

In step 702, a request to reduce power consumption by a real estate facility that houses a plurality of pieces of equipment is received. The request may be received in any suitable manner as may serve a particular implementation. For example, the request may be received by way of user input provided by way of portal 108.

In step 704, in response to the request received in 702, consolidation subsystem 102 determines that a first piece of equipment included in the plurality of pieces of equipment and associated with one or more circuits is underutilized. For example, the first piece of equipment may include a piece of telecommunication equipment connected to a plurality of circuits associated with customers of a telecommunication provider. The determination that the first piece of equipment is underutilized may be based on an analysis of source data associated with the first piece of equipment. For example, power consumption data, equipment data, circuit data, and/or any other type of source data may be used to make the determination.

In step 706, consolidation subsystem 102 identifies a second piece of equipment included in the plurality of pieces of equipment that has the capacity to handle the one or more circuits associated with the first piece of equipment. The identification may be made based on an analysis of source data associated with the second piece of equipment. For example, consolidation subsystem 102 may determine that the first and second pieces of equipment are similar in type and that the second piece of equipment may have enough empty ports to be able to support all of the circuits associated with the first piece of equipment. It will be recognized that step 706 may be performed in any other manner as may serve a particular implementation.

In step 708, a capital cost of consolidating the first and second pieces of equipment is assessed. The capital cost may be assessed based on the analysis of source data associated with the first and second pieces of equipment and/or any other data as may serve a particular implementation. In some examples, the capital cost may be too high to justify consolidation of the first and second pieces of equipment. In this case, consolidation subsystem 102 may make a recommendation to not consolidate the first and second pieces of equipment. However, if the capital cost assessment indicates that it would be worth consolidating the first and second pieces of equipment, consolidation subsystem 102 may automatically generate a recommendation to consolidate the first and second pieces of equipment, as shown in step 710. It will be recognized that the automatic generation of the recommendation may be performed in any of the ways described herein.

In step 712, a request to retire the first piece of equipment is generated in accordance with the recommendation generated in step 710. As used herein, “retiring” a piece of equipment refers to any action taken to discontinue use of the piece of equipment. Step 712 may be performed in any suitable manner as may serve a particular implementation.

In step 714, a move order is created to move the one or more circuits from the first piece of equipment to the second piece of equipment. In some examples, the move order may be automatically created in response to a user input command provided by way of portal 108. Additionally or alternatively, the move order may be automatically created in response to the request to retire the first piece of equipment.

Once the move order has been created, consolidation subsystem 102 may perform one or more other real estate consolidation operations associated with the consolidation of the first and second pieces of equipment as may serve a particular implementation. For example, consolidation subsystem 102 may update an inventory of equipment in response to a retiring of the first piece of equipment and a moving of the one or more circuits to the second piece of equipment.

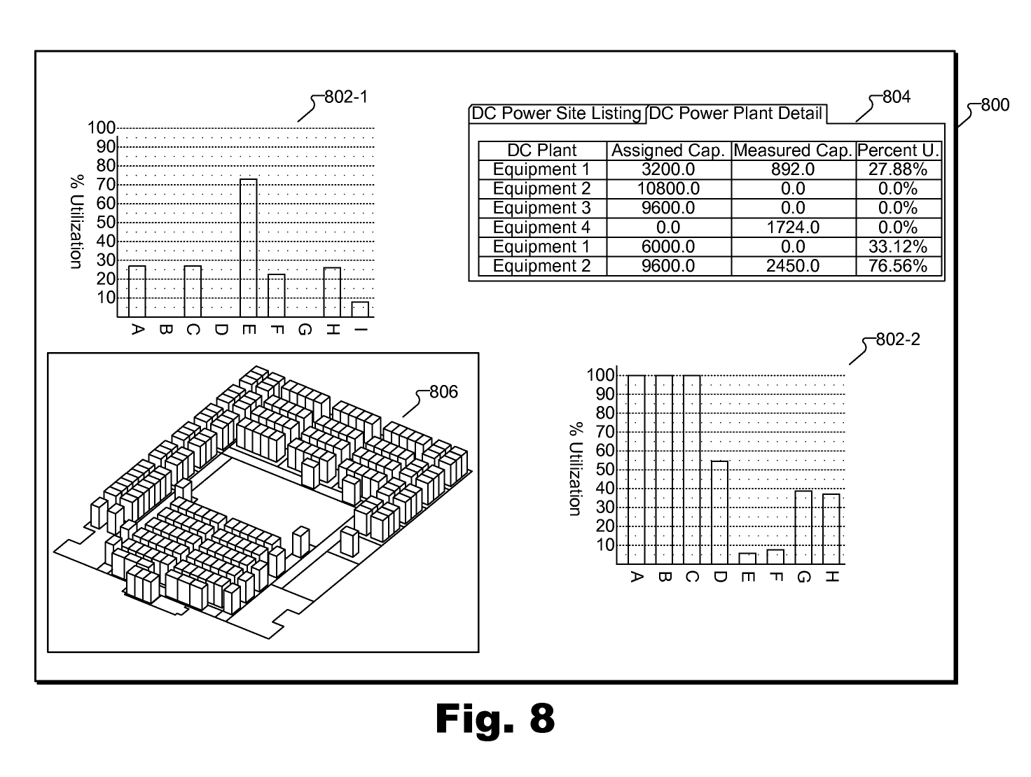

It will be recognized that portal 108 may be configured to display any type of interactive graphical object and/or information associated with one or more real estate resources as may serve a particular implementation. For example, FIG. 8 illustrates an exemplary GUI 800 that may be displayed within portal 108 and that may be configured to provide a user with various types of information associated with a particular real estate facility. To illustrate, various graphs (e.g., graphs 802-1 and 802-2) and tables (e.g., table 804) may be displayed within GUI 800 and configured to provide various types of usage and/or power consumption details associated with the real estate facility and/or one or more real estate resources (e.g., pieces of equipment) housed by the real estate facility. Additionally or alternatively, an interactive floor layout map 806 of the real estate facility may be displayed within the GUI 800. In some examples, one or more portions of floor layout map 806 may be selected in order to access usage and/or power consumption data associated with that particular selected section. In this manner, a user may more effectively analyze an efficiency of the real estate facility and determine whether to consolidate various real estate resources housed by the real estate facility.

In certain embodiments, one or more of the components and/or processes described herein may be implemented and/or performed by one or more appropriately configured computing devices. To this end, one or more of the systems and/or components described above may include or be implemented by any computer hardware and/or computer-implemented instructions (e.g., software) embodied on a non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions executable by one or more computing devices. In general, a processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known non-transitory computer-readable media.

A non-transitory computer-readable medium (also referred to as a processor-readable medium) includes any non-transitory medium that participates in providing data (e.g., instructions) that may be read by a computer (e.g., by a processor of a computer). Such a non-transitory medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of non-transitory computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other non-transitory medium from which a computer can read.

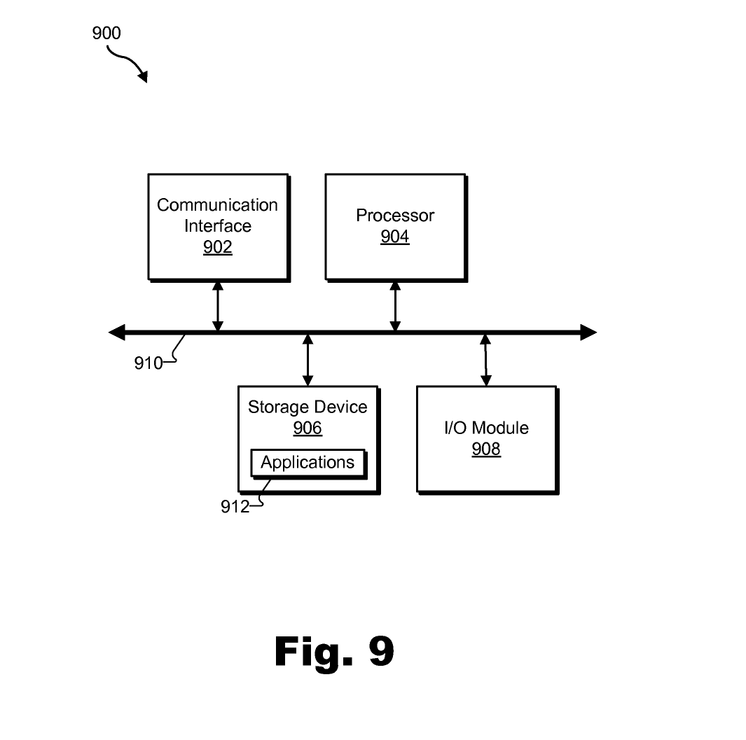

FIG. 9 illustrates an exemplary computing device 900 that may be configured to perform one or more of the processes described herein. As shown in FIG. 9, computing device 900 may include a communication interface 902, a processor 904, a storage device 906, and an input/output (“I/O”) module 908 communicatively connected via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, and any other suitable interface. Communication interface 902 may additionally or alternatively provide such a connection through, for example, a local area network (such as an Ethernet network), a personal area network, a telephone or cable network, a satellite data connection, a dedicated URL, or any other suitable connection. Communication interface 902 may be configured to interface with any suitable communication media, protocols, and formats, including any of those mentioned above.

Processor 904 generally represents any type or form of processing unit capable of processing data or interpreting, executing, and/or directing execution of one or more of the instructions, processes, and/or operations described herein. Processor 904 may direct execution of operations in accordance with one or more applications 912 or other computer-executable instructions such as may be stored in storage device 906 or another non-transitory computer-readable medium.

Storage device 906 may include one or more data storage media, devices, or configurations and may employ any type, form, and combination of data storage media and/or device. For example, storage device 906 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 906. For example, data representative of one or more executable applications 912 (which may include, but are not limited to, one or more of the software applications described herein) configured to direct processor 904 to perform any of the operations described herein may be stored within storage device 906. In some examples, data may be arranged in one or more databases residing within storage device 906.

I/O module 908 may be configured to receive user input and provide user output and may include any hardware, firmware, software, or combination thereof supportive of input and output capabilities. For example, I/O module 908 may include hardware and/or software for capturing user input, including, but not limited to, a keyboard or keypad, a touch screen component (e.g., touch screen display), a receiver (e.g., an RF or infrared receiver), and/or one or more input buttons.

I/O module 908 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

In some examples, any of the modules described herein may be implemented by or within one or more components of computing device 900. For example, one or more applications 912 residing within storage device 906 may be configured to direct processor 904 to perform one or more processes or functions associated with communication module 202, user interface module 204, analysis module 206, recommendation module 208, and/or operation module 210. Likewise, storage module 212 may be implemented by or within storage device 906.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A method comprising:
providing, by a real estate resource consolidation subsystem, an interactive map for display in a portal, the interactive map including a plurality of graphical markers representative of a plurality of real estate facilities each located at a distinct geographic location;
detecting, by the real estate resource consolidation subsystem, a selection by a user of a graphical marker included in the plurality of graphical markers and representative of a first real estate facility included in the plurality of real estate facilities;
automatically selecting, by the real estate resource consolidation subsystem, a second real estate facility included in the plurality of real estate facilities based on the selection by the user of the first real estate facility;
analyzing, by the real estate resource consolidation subsystem, source data associated with the first and second real estate facilities and maintained by a plurality of distinct source data management subsystems;
automatically generating, by the real estate resource consolidation subsystem, a plurality of recommendations for consolidating the first and second real estate facilities based on the analyzing of the source data;
providing, by the real estate resource consolidation subsystem, the plurality of recommendations for display in the portal;
detecting, by the real estate resource consolidation subsystem, a selection by a user of a particular recommendation included in the plurality of recommendations; and
performing, by the real estate resource consolidation subsystem in response to the selection by the user of the particular recommendation, at least one real estate consolidation operation associated with the first and second real estate facilities in accordance with the particular recommendation.

2. (canceled)

3. The method of claim 2, wherein the particular recommendation comprises a recommendation to consolidate the first and second real estate facilities into a single real estate facility.

4. The method of claim 3, wherein the performing of the at least one real estate consolidation operation comprises performing one or more operations associated with closing at least one of the first and second real estate facilities.

5. method of claim 1, wherein at least one of the first and second real estate facilities comprises a plurality of pieces of equipment.

6. The method of claim 5, wherein the plurality of pieces of equipment are located within a single real estate facility.

7. The method of claim 6, wherein the plurality of pieces of equipment comprise a first piece of equipment and a second piece of equipment and wherein the analyzing of the source data comprises:
identifying that the first and second pieces of equipment are underutilized; and
assessing a capital cost of consolidating the first and second pieces of equipment.

8. The method of claim 7, wherein the automatically generating of the plurality of recommendations comprises automatically generating a recommendation to consolidate the first and second pieces of equipment based on the identifying of the underutilization of the first piece of equipment and on the assessing of the capital cost.

9. The method of claim 8, wherein the performing of the at least one real estate consolidation operation comprises:
automatically generating a request to retire the first piece of equipment;
creating a move order to move circuits associated with the first piece of equipment to the second piece of equipment; and
updating an inventory of equipment in response to a retiring of the first piece of equipment and a moving of the circuits to the second piece of equipment.

10. The method of claim 1, wherein the analyzing of the source data is performed in response to input by a user by way of the portal.

11. The method of claim 1, wherein source data comprises at least one of space data, equipment data, drawings data, circuit data, and power consumption data.

12-14. (canceled)

15. The method of claim 1, wherein the portal comprises a web-based portal.

16. The method of claim 1, wherein the providing of the interactive map, the detecting of the selection by the user, the automatically selecting of the second real estate facility, the analyzing of the source data, the automatically generating of the plurality of recommendations, the providing of the plurality of recommendations, the detecting of the selection by the user of the particular recommendation, and the performing of the at least one real estate consolidation operation are implemented at least in part by computer-executable instructions on at least one non-transitory computer-readable medium.

17. A method comprising:
providing, by a real estate resource consolidation subsystem, an interactive map for display in a portal, the interactive map including a plurality of graphical markers representative of a plurality of real estate facilities each located at a distinct geographic location;
detecting, by the real estate resource consolidation subsystem, a selection by a user of a graphical marker included in the plurality of graphical markers and representative of a first real estate facility included in the plurality of real estate facilities;
automatically selecting, by the real estate resource consolidation subsystem, a second real estate facility included in the plurality of real estate facilities based on the selection by the user of the first real estate facility;
analyzing, by the real estate resource consolidation subsystem in response to the selection by the user of the first real estate facility, space data associated with the first real estate facility and the second real estate facility, equipment data associated with the first and second real estate facilities, circuit data associated with the first and second real estate facilities, and power consumption data associated with the first and second real estate facilities;
automatically generating, by the real estate resource consolidation subsystem, a plurality of recommendations for consolidating the first and second real estate facilities based on the analyzing of the space data, the equipment data, the circuit data, and the power consumption data;
providing, by the real estate resource consolidation subsystem, the plurality of recommendations for display in the portal;
detecting, by the real estate resource consolidation subsystem, a selection by a user of a particular recommendation included in the plurality of recommendations; and
performing, by the real estate resource consolidation subsystem in response to the selection by the user of the particular recommendation, at least one real estate consolidation operation associated with the first and second real estate facilities in accordance with the particular recommendation.

18. The method of claim 17, wherein the providing of the interactive map, the detecting of the selection by the user, the automatically selecting of the second real estate facility, the analyzing of the source data, the automatically generating of the plurality of recommendations, the providing of the plurality of recommendations, the detecting of the selection by the user of the particular recommendation, and the performing of the at least one real estate consolidation operation are implemented at least in part by computer-executable instructions on at least one non-transitory computer-readable medium.

19. A method comprising:
providing, by a real estate resource consolidation subsystem, an interactive map for display in a portal, the interactive map including a plurality of graphical objects representative of a plurality of pieces of telecommunication equipment;
detecting, by the real estate resource consolidation subsystem, a selection by a user of a graphical object included in the plurality of graphical objects and representative of a first piece of telecommunication equipment;
determining, by the real estate resource consolidation subsystem in response to the selection by the user of the first piece of telecommunication equipment, that the first piece of telecommunication equipment is associated with one or more circuits that are associated with one or more customers of a telecommunication provider and that the first piece of telecommunication equipment is underutilized;
identifying, by the real estate resource consolidation subsystem, a second piece of telecommunication equipment included in the plurality of pieces of telecommunication equipment that has a capacity to handle the one or more circuits;
assessing, by the real estate resource consolidation subsystem, a capital cost of consolidating the first and second pieces of telecommunication equipment;
automatically generating, by the real estate resource consolidation subsystem, a recommendation to consolidate the first and second pieces of telecommunication equipment based on the identifying of the underutilization of the first piece of telecommunication equipment and on the assessing of the capital cost;
generating, by the real estate resource consolidation subsystem, a request to retire the first piece of telecommunication equipment in accordance with the recommendation; and
creating, by the real estate resource consolidation subsystem, a move order to move the one or more circuits from the first piece of telecommunication equipment to the second piece of telecommunication equipment.

20. The method of claim 19, further comprising updating, by the real estate resource consolidation subsystem, an inventory of equipment in response to a retiring of the first piece of telecommunication equipment and a moving of the one or more circuits to the second piece of telecommunication equipment.

21. The method of claim 19, wherein the receiving, determining, identifying, assessing, automatically generating, generating, and creating are implemented at least in part by computer-executable instructions on at least one non-transitory computer-readable medium.

22. A system comprising at least one computing device that comprises:
a user interface module configured to provide an interactive map for display in a portal, the interactive map including a plurality of graphical markers representative of a plurality of real estate facilities each located at a distinct geographic location;
an operation module communicatively coupled to the user interface module and configured to
detect a selection by a user of a graphical marker included in the plurality of graphical markers and representative of a first real estate facility included in the plurality of real estate facilities, and
automatically select a second real estate facility included in the plurality of real estate facilities based on the selection by the user of the first real estate facility;
an analysis module communicatively coupled to the operation module and configured to analyze source data associated with the first and second real estate facilities and maintained by a plurality of distinct source data management subsystems;
a recommendation module communicatively coupled to the analysis module and configured to automatically generate a plurality of recommendations for consolidating the first and second real estate facilities based on the analysis performed by the analysis module;
wherein the user interface module is further configured to provide the a plurality of recommendations for display in a portal; and
wherein the operation module is further configured to
detect a selection by a user of a particular recommendation included in the plurality of recommendations, and
perform at least one real estate consolidation operation associated with the first and second real estate facilities in accordance with the particular recommendation.

23. The system of claim 22, wherein the particular recommendation comprise a recommendation to consolidate the first and second real estate facilities into a single real estate facility.

24. The system of claim 22, wherein at least one of the first and second real estate facilities comprises a first piece of equipment and a second piece of equipment and wherein the analysis module is configured to analyze the source data by:
identifying that the first and second pieces of equipment are underutilized; and
assessing a capital cost of consolidating the first and second pieces of equipment.

25. The system of claim 24, wherein the recommendation module is configured to automatically generate the plurality of recommendations by automatically generating a recommendation to consolidate the first and second pieces of equipment based on the identifying of the underutilization of the first piece of equipment and on the assessing of the capital cost.
